(19) United States
(12) Patent Application Publication
(10) Pub. No.: US 2012/0140343 A1
(43) Pub. Date: Jun. 7, 2012

(54) LENS MODULE

(75) Inventors: CHIEN-HSIN LU, New Taipei (TW); HSIANG-YU TSAI, Taipei (TW)

(73) Assignee: ABILITY ENTERPRISE CO., LTD., TAIPEI (TW)

(21) Appl. No.: 13/076,790

(22) Filed: Mar. 31, 2011

(30) Foreign Application Priority Data
Dec. 6, 2010 (TW) 099142466

(51) Int. Cl. G02B 7/04; G02B 7/02

(52) U.S. Cl. 359/823; 359/819

(57) ABSTRACT

A lens module is disclosed. The lens module includes a lead screw, a nut member, and a lens frame. The nut member is screw-jointed with the lead screw. The nut member is interlocked to the lens frame.

### BACKGROUND OF THE INVENTION

1. Field of the Invention

The present invention generally relates to a lens module, and more particularly to a lens module which is applied in a picture capturing device.

2. Description of the Prior Art

The conventional lens module usually has complex and sophisticated structure for performing the movement and the precise positioning of the lens. For example, the conventional lens module usually includes a lead screw and a nut member for performing the movement and the precise positioning of the lens. If the lens frame is blocked by foreign objects or the nut member moves too fast, the lens frame may separate from the nut member. And poor positioning of the lens may occur. In order to move the lens frame steadily by the nut member, it is necessary to dispose a spring or a plate spring on the lens frame such that the lens frame always contacts the nut member. Thus, poor positioning of the lens can be avoided. However, the complex and sophisticated structure mentioned above usually has disadvantages. For example, the yield rate of the components of the conventional lens module may be lower. The conventional lens module may be hard to assemble. And the conventional lens module may have higher cost.

For the reason that there are some disadvantages of the prior art mentioned above, there exists a need for a lens module so as to meet consumer needs.

### SUMMARY OF THE INVENTION

Accordingly, the present invention has been made in order to meet such a need described above, and it is an object of the present invention to provide a lens module so as to meet consumer needs.

In order to achieve the above object, the present invention provides a lens module. The lens module includes a lead screw, a nut member, and a lens frame. The nut member is screw-jointed with the lead screw. The nut member is interlocked to the lens frame.

By the lens module of the present invention, the nut member mentioned above is interlocked to the lens frame directly. Therefore, the lens frame can be moved steadily by the nut member without additional spring or plate spring. Thus, the lens module of the present invention has advantages. For example, the structure of the lens module is simpler. The lens module has fewer components. The lens module is easy to assemble. And the lens module has lower cost.

### BRIEF DESCRIPTION OF THE DRAWINGS

FIG. 1 shows the perspective view of a lens module in accordance with an embodiment of the present invention;

FIG. 2A and FIG. 2B show the perspective view and the sectional top view showing that the nut member is interlocked to the lens frame respectively;

FIG. 2C shows the sectional top view showing that the nut member is interlocked to the lens frame in accordance with another embodiment of the present invention; and

FIG. 2D shows the sectional top view showing that the nut member is interlocked to the lens frame in accordance with another embodiment of the present invention.

### DETAILED DESCRIPTION OF THE INVENTION

The detailed description of the present invention will be discussed in the following embodiments, which are not intended to limit the scope of the present invention, but can be adapted for other applications. While drawings are illustrated in details, it is appreciated that the quantity of the disclosed components may be greater or less than that disclosed, except expressly restricting the amount of the components.

The present invention generally relates to a lens module which can be applied in many kinds of picture capturing devices, such as digital cameras with retractable lens barrels, periscope-type digital cameras, video cameras, mobile communication systems, and so on.

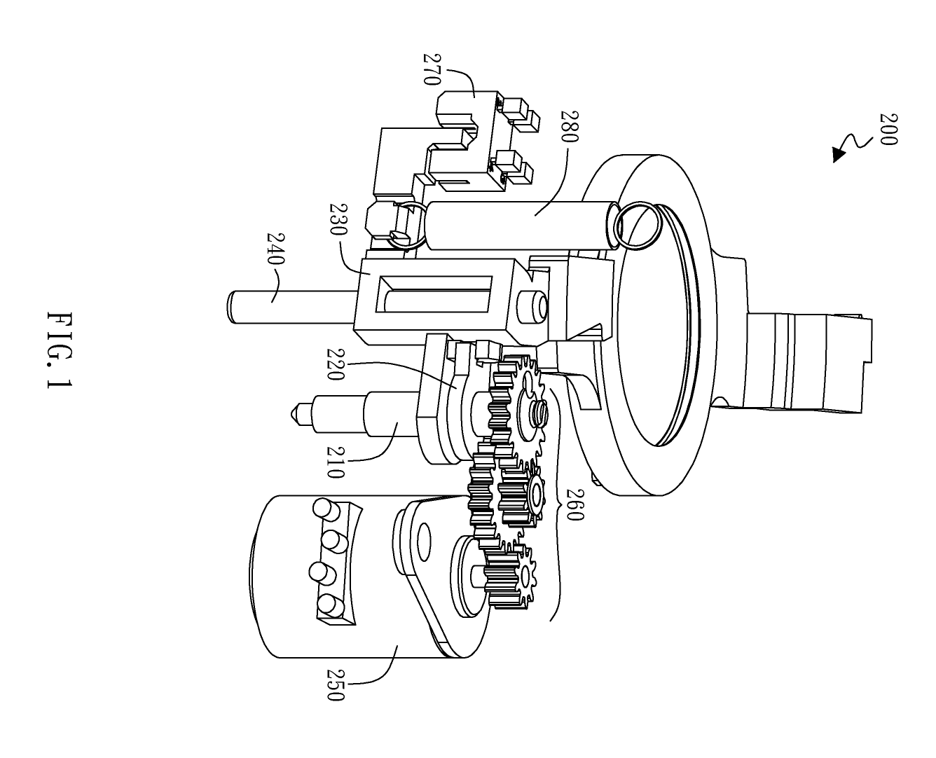

FIG. 1 shows the perspective view of a lens module 200 in accordance with an embodiment of the present invention. The lens module 200 includes a lead screw 210, a nut member 220, a lens frame 230, a guide rod 240, a driver 250, and a plurality of gears 260.

The nut member 220 is screw-jointed with the lead screw 210, and the nut member 220 is interlocked to the lens frame 230. The guide rod 240 is parallel with the lead screw 210, and the guide rod 240 passes through two positioning holes of the lens frame 230 for guiding the lens frame 230 to move linearly. The driver 250 transmits power to the lead screw 210 by the gears 260. The nut member 220 is moved linearly along the lead screw 210 when the lead screw 210 rotates.

According to this embodiment, the driver 250 is a rotary driver.

In a preferred embodiment, the driver 250 is preferably a step motor. In other preferred embodiment, the driver 250 can also be a DC motor, a servo motor, or other rotary driver. In this embodiment, the lens module 200 can further includes a sensor 270 for detecting the position of the lens frame 230 on the guide rod 240. In addition, according to this embodiment, the lens module 200 can further includes a flexible element 280. One end of the flexible element 280 is connected with the lens frame 230 for pulling the lens frame 230. Thus, the screw of the nut member 220 can contacts the screw of the lead screw 210 closely for decreasing the backlash which occurs by reciprocal movement of the lens frame 230. The flexible element 280 can be a spring, a plate spring, or other kinds of flexible elements.

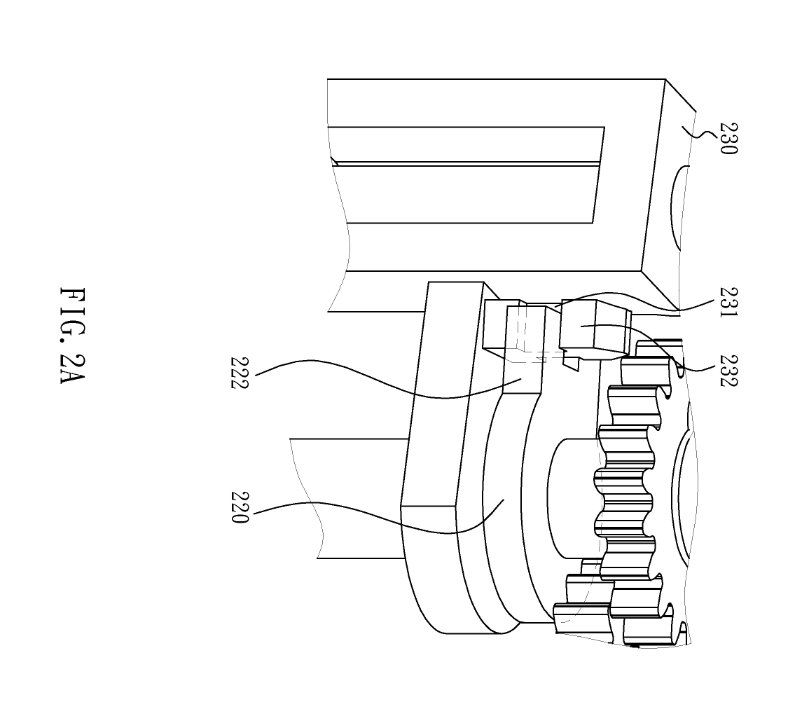

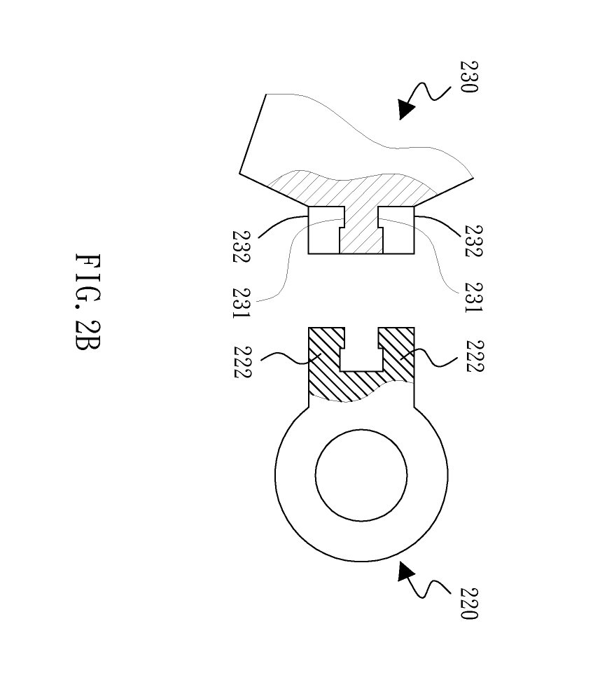

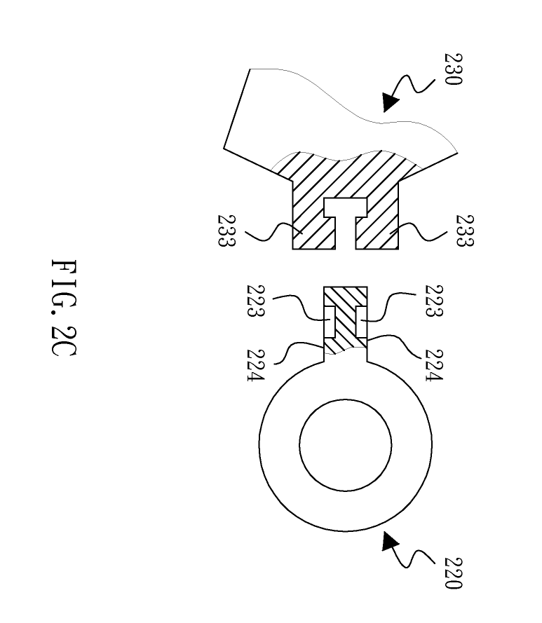

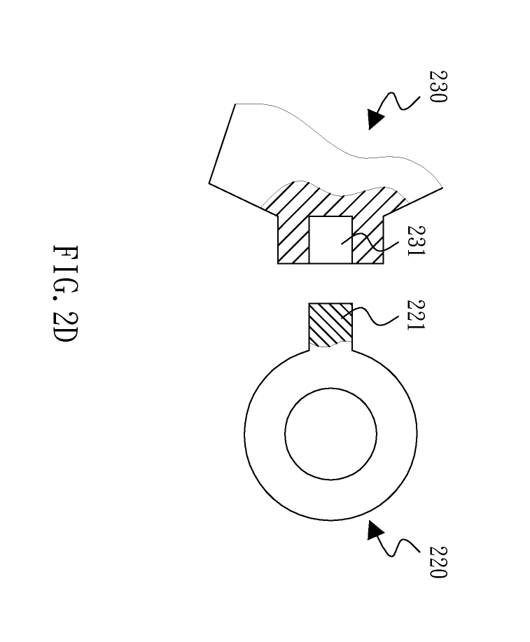

FIG. 2A and FIG. 2B show the perspective view and the sectional top view showing that the nut member 220 is interlocked to the lens frame 230 respectively. Referring to FIG. 2A and FIG. 2B, in this embodiment, the lens frame 230 includes two grooves 231, and these two grooves 231 are disposed at two side walls 232 of the lens frame 230 respectively. The nut member 220 includes two interlocking ends 222, and these two interlocking ends 222 are interlocked to these two grooves 231 respectively for fixing the nut member 220 on the lens frame 230 directly. Thus, the lead screw 210 can move the lens frame 230 steadily by the nut member 220.

FIG. 2C shows the sectional top view showing that the nut member 220 is interlocked to the lens frame 230 in accordance with another embodiment of the present invention. Referring to FIG. 2C, in this embodiment, the lens frame 230 includes two interlocking ends 233, and these two interlocking ends 233 are interlocked to the nut member 220 respectively. According to this embodiment, the nut member 220 includes two grooves 223, and these two grooves 223 are disposed at two side walls 224 of the nut member 220 respectively. These two interlocking ends 233 of the lens frame 230 are interlocked to these two grooves 223 of the nut member 220 respectively for fixing the nut member 220 on the lens frame 230 directly. Thus, the lead screw 210 can move the lens frame 230 steadily by the nut member 220.

FIG. 2D shows the sectional top view showing that the nut member 220 is interlocked to the lens frame 230 in accordance with another embodiment of the present invention. Referring to FIG. 2D, in this embodiment, the lens frame 230 includes at least one groove 231, the nut member 220 includes at least one protruding structure 221, and the protruding structure 221 is interlocked to the groove 231 for directly fixing the nut member 220 on the lens frame 230. Thus, the lead screw 210 can move the lens frame 230 steadily by the nut member 220.

According to this embodiment, the protruding structure 221 can be a convex block or a round column. The groove 231 is contoured to fit the protruding structure 221. There is a proper tolerance between the protruding structure 221 and the groove 231. Thus, the protruding structure 221 is interlocked to the groove 231 properly without the issues that the protruding structure 221 may separates from the groove 231.

By the design mentioned above, the nut member 220 is directly interlocked to the lens frame 230. Therefore, the lens frame 230 can be moved steadily by the nut member 220 without an additional spring or plate spring for making the lens frame contact the nut member. Thus, the lens module 200 of the present invention has advantages. For example, the structure of the lens module is simpler. The lens module has fewer components. The lens module is easy to assemble. And the lens module has lower cost. Moreover, the picture capturing device having the lens module 200 can meet consumer needs for the picture capturing device.

Although specific embodiments have been illustrated and described, it will be appreciated by those skilled in the art that various modifications may be made without departing from the scope of the present invention, which is intended to be limited solely by the appended claims.

What is claimed is:

1. A lens module, comprising:
a lead screw;
a nut member being screw-jointed with said lead screw; and
a lens frame being interlocked to said nut member.

2. The lens module according to claim 1, wherein said lens frame comprises at least one groove, said nut member comprises at least one protruding structure, and said protruding structure is interlocked to said groove.

3. The lens module according to claim 2, wherein said protruding structure is a convex block or a round column.

4. The lens module according to claim 1, wherein said lens frame comprises two grooves, and wherein said two grooves are disposed at two side walls of said lens frame respectively.

5. The lens module according to claim 4, wherein said nut member comprises two interlocking ends, and wherein said two interlocking ends are interlocked to said two grooves, respectively.

6. The lens module according to claim 1, wherein said lens frame comprises two interlocking ends, and wherein said two interlocking ends are interlocked to said nut member, respectively.

7. The lens module according to claim 6, wherein said nut member comprises two grooves, and wherein said two grooves are disposed at two side walls of said nut member, respectively.

8. The lens module according to claim 1, further comprising a driver, wherein said driver transmits power to said lead screw by at least one gear for making said nut member move linearly along said lead screw.

9. The lens module according to claim 1, further comprising a flexible element, wherein one end of said flexible element is connected to said lens frame.

10. The lens module according to claim 1, further comprising a sensor for detecting a position of said lens frame.

11. The lens module according to claim 1, further comprising a guide rod which is parallel with said lead screw.

12. The lens module according to claim 11, wherein said lens frame comprises two positioning holes, and wherein said guide rod passes through said positioning holes of said lens frame.

13. A lens module, comprising:
a lead screw;
a nut member comprising at least one interlocking end, said nut member being screw-jointed with said lead screw; and
a lens frame comprising at least one groove, wherein said interlocking end is interlocked to said at least one groove for making said nut member be interlocked to said lens frame.

14. The lens module according to claim 13, wherein said nut member comprises two said interlocking ends, and wherein said lens frame comprises two grooves which correspond to said interlocking ends, and wherein said two interlocking ends are interlocked to said two grooves respectively.

15. The lens module according to claim 13, further comprising a driver, wherein said driver transmits power to said lead screw by at least one gear for making said nut member move linearly along said lead screw.

16. The lens module according to claim 13, further comprising a guide rod which is parallel with said lead screw, wherein said lens frame comprises two positioning holes, and wherein said guide rod passes through said positioning holes of said lens frame.

17. A lens module, comprising:
a lead screw;
a nut member comprising at least one groove, said nut member being screw-jointed with said lead screw; and
a lens frame comprising at least one interlocking end, wherein said at least one interlocking end is interlocked to said at least one groove for making said nut member be interlocked to said lens frame.

18. The lens module according to claim 17, wherein said nut member comprises two grooves, and wherein said lens frame comprises two interlocking ends, and wherein said two interlocking ends are interlocked to said two grooves respectively.

19. The lens module according to claim 17, further comprising a driver, wherein said driver transmits power to said lead screw by at least one gear for making said nut member move linearly along said lead screw.

20. The lens module according to claim 17, further comprising a guide rod which is parallel with said lead screw, wherein said lens frame comprises two positioning holes, said guide rod passes through said positioning holes of said lens frame.
